(19) United States
(12) Patent Application Publication
(10) Pub. No.: US 2010/0126755 A1
(43) Pub. Date: May 27, 2010

(54) ELECTRIC CONDUCTOR WITH GOOD CURRENT CAPABILITY AND A METHOD FOR IMPROVING THE CURRENT CAPABILITY OF AN ELECTRIC CONDUCTOR

(76) Inventor: Chiu-Fang Chang, Hsin-Chu (TW)

Correspondence Address: STOUT, UXA, BUYAN & MULLINS LLP, 4 VENTURE, SUITE 300, IRVINE, CA, 92618, US

(21) Appl. No.: 12/369,665

(22) Filed: Feb. 11, 2009

(30) Foreign Application Priority Data
Nov. 21, 2008 (TW) 097145145

(51) Int. Cl. H01B 5/00

(52) U.S. Cl. 174/126.1

(57) ABSTRACT

The present invention relates to an electric conductor with large current capability and a method for enhancing current capability of an electric conductor, and particularly relates to a test probe with good current capability and a method for improving the current capability of a test probe. In the present invention, dents are formed on the surface of an electric conductor to make the surface rough, so that the electric conductor can have a greater surface area. The larger surface area of the electric conductor provides more paths for passage of the electric current in order to improve the current capability of the electric conductor.

### BACKGROUND OF THE INVENTION

1. Field of the Invention

The present invention relates to an electric conductor and a method for improving the current capability of an electric conductor, and particularly relates to a test probe and a method for improving the current capability of a test probe.

2. Description of the Prior Art

In the manufacturing process and package process of electronic elements, and after the manufacturing process of electronic elements is finished, a test is performed to recognize and confirm the quality of the electronic elements or chips. During the test process, it is necessary to provide an electric conductor for the electrical connection between an electronic element and a test apparatus, and for transferring test signals between the electronic element and the test apparatus. In general, a test probe is used as the electric conductor.

However, as electronic elements advance in popularity and diversification, various kinds of electronic elements have been and continue to be developed. Therefore, a test apparatus needs to be able to test various kinds of electronic elements. In test processes, different kinds of electronic elements need different test conditions, such as different electric currents and different voltages. In recent years, larger electric currents often need the testing of many kinds of electric elements. A typical or commonly used test probe is often too small to endure passage of larger electric currents. Such a test probe can be said to have a low current capability because of its small size. Because of this, in the test process of electric elements requiring large electric currents, the typical test apparatus must be halted and time must be expended to change the test probe(s) to a particular test probe(s) having a higher current capability. Therefore, the test cost and the test time are increased, and the test efficiency and test rate are commensurately reduced. In some instances, manufacture of a new test probe, afresh, can be necessary when large electric current testing is needed. It can be impossible, however, to generate a test probe having sufficient current capability by directly improving the test probe commonly used. This kind of preparation of new test probes having higher current capability can disadvantageously add to the test cost of test processes requiring large electric currents. Hence, there is a need to provide an electric conductor with good current capability and a method for improving the current capability of an electric conductor, and particularly to provide a method to change a typical test probe into a test probe having high current capability using only a simple step.

### SUMMARY OF THE INVENTION

In view of the foregoing, it is an object of the present invention to provide an electric conductor with high current capability that is capable of improving the current capability of a common test probe, thereby reducing the test cost and increasing the test efficiency.

Another object of the present invention is to provide a method which can be used for improving the current capability of an electric conductor, and which is capable of improving the current capability of a common test probe, thereby reducing the test cost and increasing the test efficiency.

Still another object of the present invention is to provide a method for improving the current capability of a typical or common electric conductor by implementing only a simple step, without destroying the surface of the electric conductor or the plated layer on the surface of the electric conductor. This method also can be performed for increasing the hardness of the surface of the electric conductor.

According to one or more of the objects, an embodiment of the present invention provides an electric conductor with high current capability. The electric conductor comprises a body, at least one conducting part disposed on the body for connecting with an electric element or elements, and a plurality of dents formed on the surfaces of the body and the conducting part. The surface of the electric conductor can be formed as a lumpy surface owing to the existence of dents formed on surfaces of the body and the conducting part. In contrast to the relatively smooth surface of a typical or common test probe, the electric conductor of the present invention has a rough surface and a correspondingly larger surface area. Therefore, the electric conductor of the present invention is capable of enduring the passage of large electric currents, and thus can be said to possess good current capability.

According to the objects, another embodiment of the present invention provides a method for improving the current capability of an electric conductor, and particularly provides a method for improving the current capability of a common or typical electric conductor by way of only a simple step. This method does not destroy or damage the surface of the electric conductor or the plated layer on the surface of the electric conductor. First, an electric conductor is provided. The electric conductor can be a test probe or any conductor used to electrically connect any element with any apparatus. The electric conductor can be, for example, any sort of a test probe. Next, a plurality of dents are formed on the surface of the electric conductor for increasing the roughness and the surface area of the electric conductor. Therefore, the electric conductor allows and endures the passage of large electric current, and the current capability of the electric conductor is improved.

An effect achieved by the present invention which is not present in the prior art is the provision of an electric conductor with high current capability that is capable of performing a test process with large electric current. The test process need not be interrupted to stop the test apparatus and expend time changing test probes. Accordingly, additional test cost and test time caused by the changing of test probes can be omitted, and the test efficiency can be improved. Another effect achieved by the present invention which is absent from the prior art is the provision of a method that is capable of improving the current capability and the hardness of a typical or common electric conductor (e.g., test probe) without destroying, damaging, or wearing the surface of the electric conductor or of a plated layer on a surface of the electric conductor.

### BRIEF DESCRIPTION OF THE DRAWINGS

FIG. 1A and FIG. 1B are a stereophonic view and a cross-sectional view, respectively, of an electric conductor with good current capability according to one embodiment of the present invention;

FIG. 2 is a side view illustrating an electric conductor with good current capability according to another embodiment of the present invention;

FIG. 3 is a stereophonic view illustrating an electric conductor with good current capability according to still another embodiment of the present invention; and

FIG. 4 is a flow chart illustrating a method for improving the current capability of an electric conductor according to one embodiment of the present invention.

### DETAILED DESCRIPTION OF THE INVENTION

The following is a detailed description of the embodiments of the present invention. It is appreciated that the processes and structures described below do not entirely encompass whole processes and structures. The present invention can be practiced in conjunction with various fabrication techniques, and only the commonly practiced processes are included to provide an understanding of the present invention.

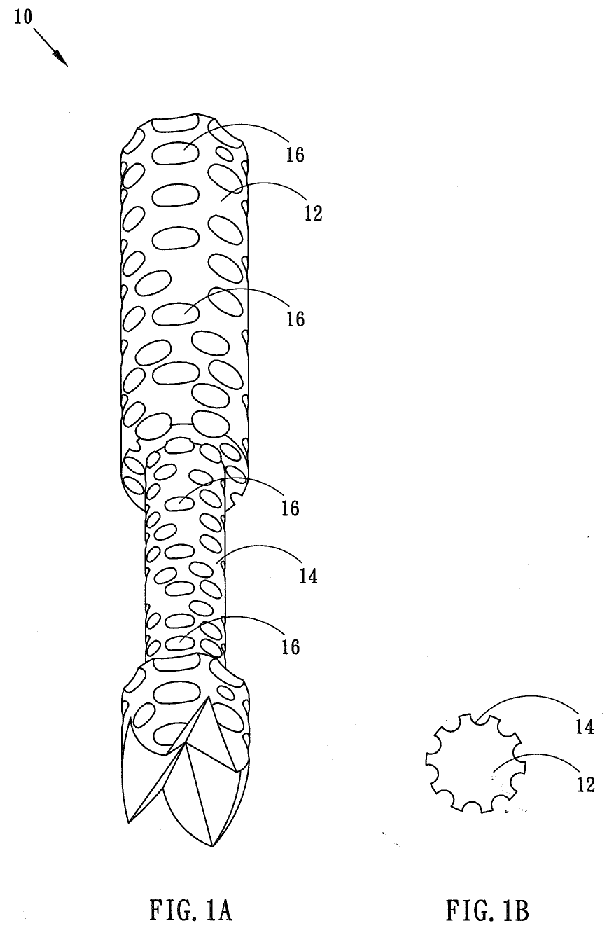

Referring to FIG. 1A, depicted is a stereophonic view illustrating an electric conductor 10 with good current capability according to one embodiment of the present invention. The electric conductor 10 comprises a body 12 and at least one conducting part 14, wherein the conducting part 14 is disposed on the body 12 for contacting an electric element. Furthermore, there are a plurality of small dents 16 formed and spread (e.g., distributed) on the surfaces of one or more of the body 12 and the conducting part 14 (or on the surfaces of the sidewalls of the body 12 and the conducting part 14). Both of the surfaces of the body 12 and the conducting part 14 become lumpy surfaces because of the dents 16 formed on the surfaces of the body 12 and the conducting part 14. Therefore, both of the body 12 and the conducting part 14 have a rougher surface and a larger surface area.

In general, electric current moves on the surface of an electric conductor, and the electric current is transferred to one or more electric elements through the surface of the electric conductor. Therefore, the larger surface area the electric conductor has, the more paths for transferring the electric current the electric conductor has. This relationship means more electric current can pass over and/or through the electric conductor at the same time providing the electric conductor with better current capability. Consequently, the current capability of an electric conductor can be said to be determined by the size of the electric conductor. The present invention uses the above-mentioned principle to form the dents 16 on surfaces of one or more of the body 12 and the conducting part 14 by, for example, one or more of shot penning, sand brush, laser beam striking, or embossing. Therefore, in contrast to common test probes currently used, the electric conductor of the present invention has a larger surface area and has better current capability because of the larger surface area. The term “laser beam striking” means a laser beam is applied to strike the surface of an object to form dents thereon. Referring to FIG. 1B, a top view or a cross-section view illustrating the electric conductor 10 is provided, in which the peripheral line of each cross-section of said electric conductor 10 is longer than the peripheral line of each cross-section of the common test probe used currently because of the dents 16. This characteristic means that the electric conductor 10 has a larger surface area than that of the common test probe used currently. Therefore, the electric conductor 10 can be provided with a larger surface area for electric current pass whereby the electric conductor 10 is enabled with a higher current capability. The term “peripheral line” means the circumference of a cross-section of the object and all peripheral lines of the object are integrated together to constitute the surface of the sidewalls of the object.

According to a user's need and design, the electric conductor 10 can be composed of various kinds of materials, for example metal, alloy, etc. Therefore, the composition of the electric conductor 10 is not intended to be limited by the examples provided in the current disclosure of the present invention. Now, in this embodiment of the present invention, the electric conductor 10 is a pogo pin, and particularly is a test probe with single head or a pogo pin with single head. Also, in the embodiment the body 12 is the body of the test probe with a single head, and the conducting part 14 is the head of the test probe with a single head.

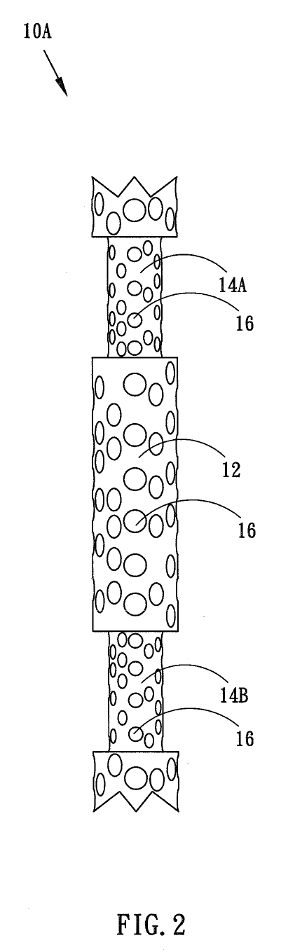

FIG. 2 illustrates an electric conductor 10A with good current capability according to another embodiment of the present invention. The electric conductor 10A is a test probe with two heads. The electric conductor 10A comprises a conducting part 14A disposed on one end of the body 12 and another conducting part 14B disposed on another end of the body 12. Both of the conducting part 14A and the conducting part 14B are the heads of the test probe. A plurality of dents 16 are formed on the surfaces of the body 12, the conducting part 14A and the conducting part 14B, thereby transforming the surface of the electric conductor 10A to a lumpy surface and providing the electric conductor 10A with a rougher surface and a larger surface area. The rougher surface and the larger surface area result in the electric conductor 10A having a substantially better current capability.

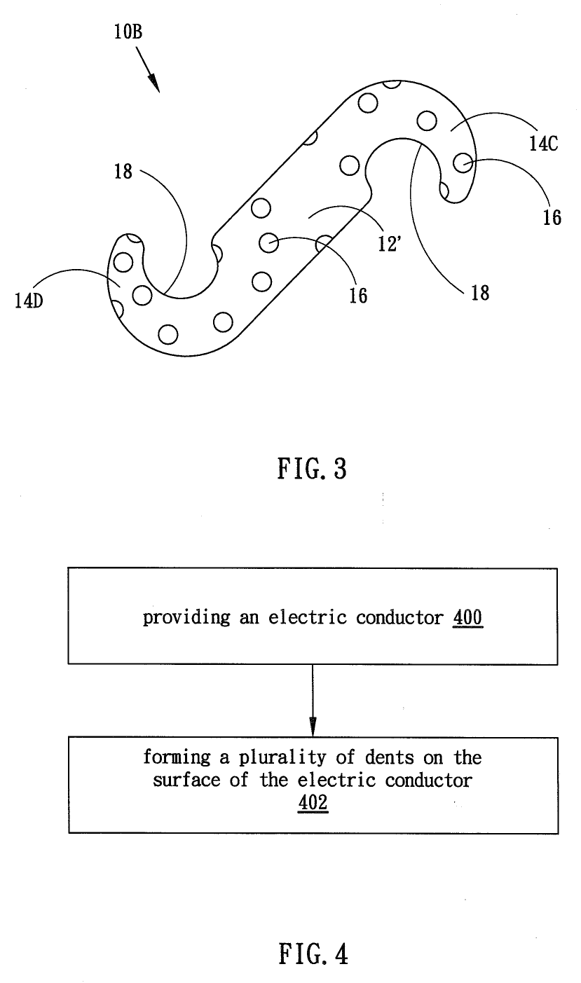

According to certain aspects, the electric conductor of the present invention need not be limited to the above-described embodiments in which the electric conductor is a test probe with single head or a test probe with two heads. Indeed, the electric conductor can comprise various kinds of and various shapes of, for example, test probes according to the user's need and design. For instance, a test probe with an S shape, such as, for example, manufactured by JONSTECH company, etc., can comprise an electric conductor 10B with good current capability, as illustrated in FIG. 3 according to still another embodiment of the present invention. The electric conductor 10B is a test probe in the form of an electric conductor 10B which, when viewed from the side, comprises or resembles the shape of an S shaped slab with a relatively small size. The electric conductor 10B as depicted comprises a body 12′ which is the body of the S-shaped test probe, and two conducting parts 14C and 14D which are the curved heads of the S-shaped test probe. The conducting part 14C and the conducting part 14D are disposed on two (e.g., opposing) ends of the body 12′ respectively. Similarly, a plurality of the dents 16 are formed on the surfaces of the body 12′ and the conducting parts 14C and 14D for increasing the surface roughness and the surface area of the electric conductor 10B. Therefore, the resulting electric conductor 10B can have higher current capability. The S-shaped test probe can be fixed on a test apparatus by inserting two rubber strips into the two concaves of the S-shaped test probe respectively.

However, in any electric conductor of the embodiments of the present invention, one or several plated layers could be formed on the surface of the body, the surface of the conducting part or both surfaces of the body and the conducting part for providing various functions. For example, a plated layer or layers can form either or both of a protective layer for protecting the body and/or conducting part from oxidization or an impact endurance layer for improving the impact resistance of the electric conductor. The protective layer can be, but is not limited to, an Au layer, and the impact endurance layer can be, but is not limited to, a Ni layer. Such items can be composed of various materials according to the user's need. The dents on the electric conductor can comprise dents on the surface of the electric conductor and/or dents on a plated layer formed over an impact endurance layer, wherein the plated layer is not damaged and worn to expose the underlying plated layer or the surface of the electric conductor under the plated layer.

The present invention further provides a method for improving the current capability of an electric conductor while not damaging or wearing the surface of the electric conductor or the plated layer on the surface of the electric conductor. With reference to FIG. 4, a flow chart is presented illustrating the method for improving current capability of an electric conductor according to one embodiment of the present invention. First, an electric conductor is provided at step 400. The electric conductor can be any conductor for electrically connecting an element with an apparatus or for electrically connecting one apparatus with another apparatus, for example a common or typical test probe, a test probe with single head, a test probe with two heads, or a test probe with an S shape. The composition and the shape of the electric conductor described above are not mentioned again. One or more plated layers can be formed on the surface of the body of the electric conductor, on the surface of the conducting part of the electric conductor, or on the surfaces of both of the body and the conducting part for providing various functions, such as that of a protective layer for protecting the body and/or conducting part from oxidization or an impact endurance layer for improving the impact resistance of the electric conductor.

Next, at step 402 a plurality of dents are formed on surfaces of the body and the conducting part by a process such as shot penning, sand brush, laser beam striking, or embossing. The surface of the electric conductor is transformed to a lumpy surface as a result of the dents, and the electric conductor consequently has a better current capability because of the lumpy surface. Consistent with principles mentioned above, when plating is present on the surface of the electric conductor, the dents can be formed on either or both of the surfaces of the electric conductor and the plated layer. Therefore, the present invention provides a method for improving the current capability of a common electric conductor using a simple step, which is capable of effectively improving the current capability of a typical or common electric conductor currently used.

When the dents are formed on surfaces of both the body and the conducting part of the electric conductor by shot penning or sand brush, small particles are applied to impact or strike the surface of the electric conductor to form the dents on the surface of the electric conductor. If there is a plated layer on the surface of the electric conductor, the small particles can be directed to impact or strike the surfaces of the electric conductor and the plated layer thereby forming dents on the surfaces of the electric conductor and the plated layer. The small particles are softer than the electric conductor and/or softer than the plated layer on the surface of the electric conductor. Therefore, when the small particles are applied to impact or strike the surface of the electric conductor and the plated layer on the electric conductor, only dents are formed on the surface of the electric conductor or the plated layer on the electric conductor without any damage and wearing to the electric conductor. The small particles are steel balls, glass sand particles, or sand, but are not intended to be limited to such items. Various small particles can be applied according to the kind of electric conductor to be used and the user's needs. It may be necessary in certain implementations that the surfaces of the electric conductor and the plated layer thereon are not damaged and worn by the small particles. Furthermore, the hardness of the electric conductor is increased as a result of the arrangement of the crystal lattice of the electric conductor being changed by the small particle impacts or the crystal lattice of the electric conductor being deformed by the small particle impacts.

Similarly, a laser beam striking or embossing technique can be applied only to impact or oppress the surface of the electric conductor or the plated layer thereon for forming the dents on the surface of the electric conductor or the plated layer thereon, or on both of the surfaces of the electric conductor and the plated layer. Therefore, a lumpy surface can be formed on the electric conductor for increasing the surface area of the electric conductor. It may be necessary that the surface of the electric conductor and the plated layer thereon are not damaged and worn by this way, either.

Accordingly, the present invention provides an electric conductor with a high current capability. The surface area of the electric conductor is increased by the formation of dents for obtaining better current capability. In accordance with the present invention, stopping of the test apparatus and expending time to change test probes can be avoided. Accordingly, additional test costs and test times caused by having to change test probes can be omitted, and the test efficiency can be improved. Furthermore, the present invention provides a method for improving the current capability of an electric conductor by forming dents on a typical or common electric conductors in a simple manner. By the method of the present invention, the roughness of the surface of the electric conductor and the surface area of the electric conductor are increased for improving the current capability of the electric conductor, while not destroying, damaging, or wearing the surface of the electric conductor or the plated layer on the surface of the electric conductor.

What is claimed is:

1. An electric conductor with good current capability, comprising:
a body;
at least one conducting part; and
a plurality of dents formed on surfaces of said body and said conducting part.

2. The electric conductor of claim 1, wherein said plurality of dents forms a lumpy surface and increases the surface area and the current capability of said electric conductor, whereby a larger electric current can be conducted by said electric conductor than could be conducted by said electric conductor without the lumpy surface.

3. The electric conductor of claim 1, wherein a lumpy surface is provided on said electric conductor by said plurality of dents on the surface of said conducting part for increasing the surface area and the current capability of said conducting part, whereby a larger electric current is allowed to pass over said conducting part than would be allowed to pass over said conducting part without the lumpy surface.

4. The electric conductor of claim 1, wherein said plurality of dents is formed on the surfaces of said body and said conducting part by shot penning, sand brush, or laser beam striking without damage of a plated layer on said body and said conducting part.

5. The electric conductor of claim 1, further comprising a protective layer formed on said conducting part for preventing said conducting part from oxidization.

6. The electric conductor of claim 5, wherein said protective layer is an Au layer.

7. The electric conductor of claim 1, wherein said electric conductor is a probe, said body is a probe body, and said conducting part is a head of the probe.

8. The electric conductor of claim 1, wherein said probe is a pogo pin, a probe with single head, a probe with two heads, or a probe with an S shape.

9. A method for improving the current capability of an electric conductor, comprising:
providing an electric conductor; and
forming a plurality of dents on a surface of said electric conductor for increasing both a roughness of the surface of said electric conductor and a surface area of said electric conductor.

10. The method of claim 9, wherein said electric conductor, comprises:
a body; and
at least one conducting part.

11. The method of claim 9, wherein said a plurality of dents is formed on the surface of said electric conductor by shot penning or sand brush.

12. The method of claim 11, wherein said shot penning or said sand brush directs small particles to strike the surface of said electric conductor for forming a plurality of dents thereon.

13. The method of claim 12, wherein said small particles are steel balls, glass sand particles or sand.

14. The method of claim 12, wherein said small particles are softer than one or more of said electric conductor or a plated layer on said electric conductor.

15. The method of claim 14, wherein said small particles strike said electric conductor for changing the crystal lattice of the surface of said electric conductor, and wherein a hardness of the surface of said electric conductor is increased.

16. The method of claim 9, wherein a laser beam is provided to strike the surface of said electric conductor for forming said plurality of dents on the surface of said electric conductor.

17. The method of claim 9, wherein the step of forming a plurality of dents is performed to form said plurality of dents on the surface of said electric conductor for making the surface of said electric conductor become a lumpy surface, whereby the roughness of one or more of the surface of said electric conductor and the surface area of said electric conductor is increased.

18. The method of claim 16, wherein said lumpy surface makes a peripheral line of each cross-section of said electric conductor to be longer for increasing the surface area available to pass large electric currents and for improving the current capability of said electric conductor.
